(19) United States
(12) Patent Application Publication
(10) Pub. No.: US 2025/0097239 A1
(43) Pub. Date: Mar. 20, 2025

(54) DISPLAY DEVICE, DISPLAY METHOD, AND RECORDING MEDIUM

(71) Applicant: NEC Corporation, Tokyo (JP)

(72) Inventors: Shota KIZUKURI, Tokyo (JP); Takahisa Yutoku, Tokyo (JP); Kei Takai, Tokyo (JP)

(73) Assignee: NEC Corporation, Tokyo (JP)

(21) Appl. No.: 18/810,672

(22) Filed: Aug. 21, 2024

(30) Foreign Application Priority Data
Sep. 19, 2023 (JP) 2023-150831

(51) Int. Cl. H04L 9/40

(52) U.S. Cl. CPC H04L 63/1416

(57) ABSTRACT

A display device includes at least one memory configured to store instructions; and at least one processor configured to execute the instructions to: acquire cyberattack information including information of a damaged company by a plurality of cyberattack groups using a dedicated tool or a website browsable by performing specific setting; and display the cyberattack information of the plurality of cyberattack groups.

This application is based upon and claims the benefit of priority from Japanese Patent Application No. 2023-150831, filed on Sep. 19, 2023, the disclosure of which is incorporated herein in its entirety by reference.

### TECHNICAL FIELD

The present disclosure relates to a display device, a display method, and a recording medium.

### BACKGROUND ART

There is a technology for providing a trend regarding a cyberattack. For example, JP 2021-131715 A discloses a technology of recommending an article such as threat information regarding a cyberattack to a user.

### SUMMARY

An example of an object of the present disclosure is to provide a display device or the like capable of grasping a trend of a cyberattack.

A display device according to an aspect of the present disclosure includes: at least one memory configured to store instructions; and at least one processor configured to execute the instructions to: acquire cyberattack information including information of a damaged company by a plurality of cyberattack groups using a dedicated tool or a website browsable by performing specific setting; and display the cyberattack information of the plurality of cyberattack groups.

In a display method according to an aspect of the present disclosure, a computer executes: acquiring cyberattack information including information of a damaged company by a plurality of cyberattack groups by using a dedicated tool or a website browsable by performing specific setting; and displaying the cyberattack information by the plurality of cyberattack groups.

A program according to an aspect of the present disclosure execute: acquiring cyberattack information including information of a damaged company by a plurality of cyberattack groups using a dedicated tool or a website browsable by performing specific setting; and displaying the cyberattack information by the plurality of cyberattack groups.

The program may be stored in a non-transitory computer-readable recording medium.

### BRIEF DESCRIPTION OF THE DRAWINGS

Exemplary features and advantages of the present disclosure will become apparent from the following detailed description when taken with the accompanying drawings in which:

FIG. 1 is a functional block diagram illustrating an example of a configuration of a display device in the present disclosure;

FIG. 2 is a diagram illustrating a hardware configuration in which the display device in the present disclosure is implemented by a computer device and its peripheral devices;

FIG. 3 is an example of a display screen displaying cyberattack information by a plurality of cyberattack groups in the present disclosure;

FIG. 4 is a flowchart illustrating an operation of the display device in the present disclosure;

FIG. 5 is a functional block diagram illustrating an example of a configuration of the display device in the present disclosure;

FIG. 6A is an example of a display screen displaying the number of cyberattacks of each cyberattack group in the present disclosure;

FIG. 6B is an example of a display screen displaying the number of cyberattacks of each cyberattack group in the present disclosure;

FIG. 7 is an example of a display screen displaying the number of cyberattacks of each type of damaged company in the present disclosure;

FIG. 8 is an example of a display screen displaying the number of cyberattacks of each type of damaged company in the present disclosure; and

FIG. 9 is a flowchart illustrating an operation of the display device in the present disclosure.

### EXAMPLE EMBODIMENT

Hereinafter, example embodiments of a display device, a display method, a program, and a non-transitory recording medium recording the program according to the present disclosure will be described in detail with reference to the drawings. The present example embodiment does not limit the disclosed technology.

### First Example Embodiment

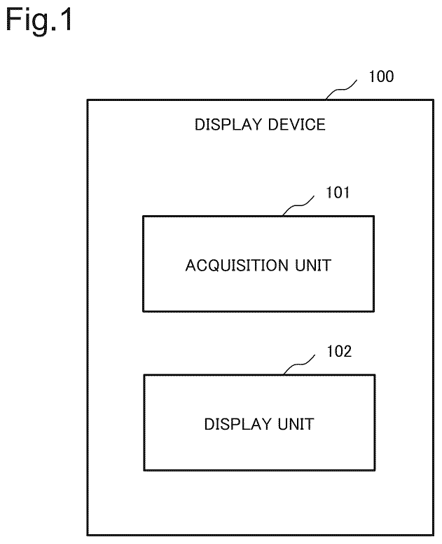

FIG. 1 is a functional block diagram illustrating an example of a configuration of a display device 100 in the present disclosure. The display device 100 is a device for displaying the cyberattack information of the plurality of cyberattack groups. Referring to FIG. 1, the display device 100 includes an acquisition unit 101 and a display unit 102.

A cyberattack group refers to an attack subject who performs a cyberattack on a company, and a form thereof is not limited. The attack subject may be an individual or a group. The cyberattack method is not particularly limited, and examples thereof include a cyberattack by ransomware.

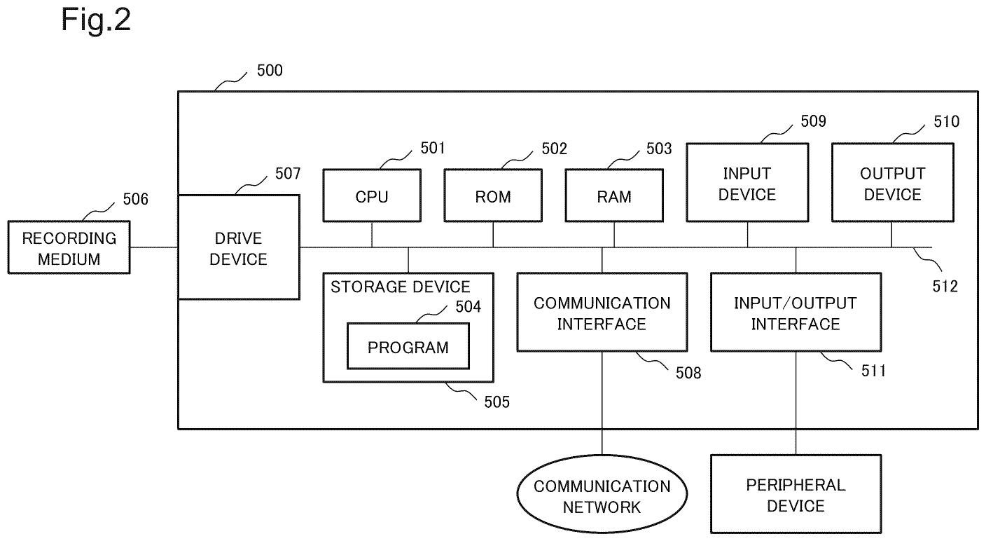

FIG. 2 is a diagram illustrating an example of a hardware configuration in which the display device 100 in the present disclosure is achieved by a computer device 500 including a processor. As illustrated in FIG. 2, the display device 100 includes a central processing unit (CPU) 501, a memory such as a read only memory (ROM) 502 and a random access memory (RAM) 503, a storage device 505 such as a hard disk that stores a program 504, a communication interface 508 for network connection, and an input/output interface 511 that inputs and outputs data.

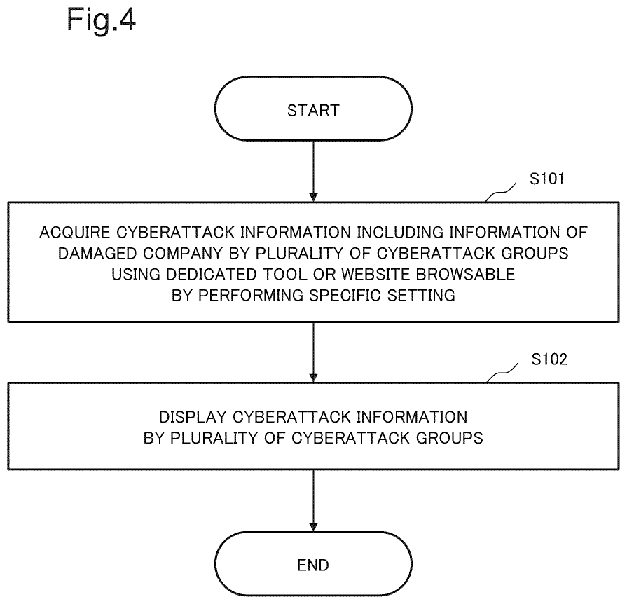

The CPU 501 operates the operating system to control the display device 100 according to the present disclosure. The CPU 501 reads a program and data from a recording medium 506 mounted on, for example, a drive device 507 to a memory. The CPU 501 functions as the acquisition unit 101, the display unit 102, and a part thereof in the present disclosure, and executes processing or commands in the flowchart illustrated in FIG. 4 to be described later based on a program.

The recording medium 506 is, for example, an optical disk, a flexible disk, a magnetic optical disk, an external hard disk, a semiconductor memory, or the like. A part of the recording medium of the storage device is a non-volatile storage device, and records a program in the part. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to confirm displaying.

As described above, the display device 100 in the present disclosure is implemented by the computer hardware illustrated in FIG. 2. However, the means for implementing each unit included in the display device 100 of FIG. 1 is not limited to the configuration described above. The display device 100 may be implemented by one physically coupled device, or may be implemented by a plurality of devices by connecting two or more physically separated devices in a wired or wireless manner. The display device 100 may further include a display device such as a display, or may be configured as a system implemented by a device separate from the display device 100.

The acquisition unit 101 acquires the cyberattack information including the information of a damaged company by a plurality of cyberattack groups using a dedicated tool or a website browsable by performing specific setting.

Here, the cyberattack information to be monitored in the present disclosure will be described. The Internet space is divided into three spaces of a surface web, a deep web, and a dark web. The surface web is an aggregation of ordinary websites without anonymity, and is a high accessible web space that can be searched by a general search engine. The deep web is a web space that exists in a web space having no anonymity as a transmission source but is not displayed in search by a search engine, or is closed as a member and cannot be recognized by the search engine. The dark web is a web space having anonymity as a transmission source, and is a site space separated for each privacy service, which cannot be searched by a general search engine. As the privacy service, there are the onion router (Tor) and the invisible internet project (I2P). In the present disclosure, the acquisition unit 101 acquires cyberattack information of threats (exposed ransomware) active in spaces of the deep web and the dark web.

The acquisition unit 101 acquires the cyberattack information from the deep web and the dark web by, for example, the following method. That is, the acquisition unit 101 acquires the cyberattack information by monitoring and analyzing a specific site or a specific social networking service (SNS: Telegram) as a monitoring target for the deep web. In this case, the acquisition unit 101 monitors a specific site or SNS using an RSS feed, direct access to a URL, a Telegram app, or the like. The acquisition unit 101 acquires the cyberattack information by specifying tools or setting the dark web. The acquisition unit 101 utilizes, for example, browsing using a Tor browser or web scraping through socks5 proxy settings in Tor (Tor.exe) and Python. The acquisition unit 101 acquires the cyberattack information by monitoring and analyzing the specific site set as the monitoring target.

The acquisition unit 101 acquires the cyberattack information by, for example, a crime statement of the cyberattack by each cyberattack group posted on the dark web. The cyberattack information includes at least a cyberattack group name, an attack date, and information of a damaged company. The cyberattack group name includes not only a known group name but also a newly appeared group name. The information on a damaged company may include information on the name of the damaged company, the business type, the location of the company, and the country of the company. In the present specification, the country of the company refers to the location of the headquarter of the company. If the cyberattack group name, the attack date, and the information of the damaged company described above are posted, the acquisition unit 101 may acquire the cyberattack information from information other than the crime statement of the cyberattack group. When acquiring the cyberattack information by the plurality of cyberattack groups, the acquisition unit 101 outputs the information to the display unit 102.

The display unit 102 is a means for displaying the cyberattack information by the plurality of cyberattack groups. A display unit 103 causes the output device 510 or the like to display the cyberattack information. The display unit 103 may generate a screen indicating the cyberattack information and cause a device different from the display device 100 to display the generated screen.

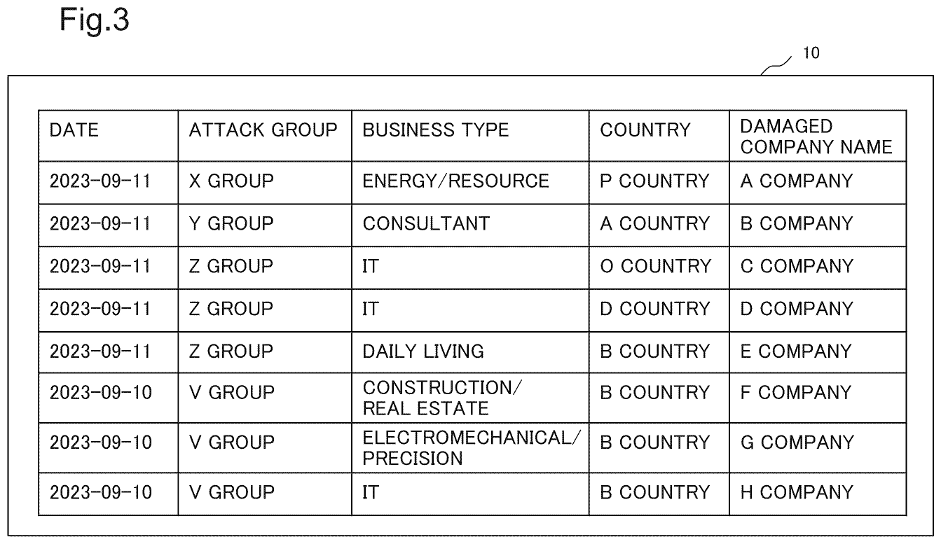

FIG. 3 is an example of a display screen displaying cyberattack information by a plurality of cyberattack groups in the present disclosure. As illustrated in FIG. 3, a list of the attack date, the attack group name, the business type of damaged company, the country name of the damaged company, and the damaged company name is displayed as each piece of the cyberattack information. In FIG. 3, for example, a filtering function may be provided so as to display only specific cyberattack information. For example, the display unit 102 may accept selection of the attack date, the attack group, and the information of the damaged company, and display only the selected cyber company information. The display unit 102 may change the display mode according to the size of the scale of the damaged company. For example, in a case where the scale of the damaged company is a predetermined scale or more, the display unit 102 may highlight the damaged company by changing the color or font of the characters.

The operation of the display device 100 configured as described above will be described with reference to the flowchart of FIG. 4.

FIG. 4 is a flowchart illustrating an outline of the operation of the display device 100 in the present disclosure. The processing according to this flowchart may be executed based on program control by the processor described above.

As illustrated in FIG. 4, first, the acquisition unit 101 acquires the cyberattack information including the information of the damaged company by the plurality of cyberattack groups using a dedicated tool or a website browsable by performing specific setting (step S101). Next, the display unit 102 displays the cyberattack information by the plurality of cyberattack groups (step S102). Thus, the display device 100 ends the operation.

In the display device 100 in the present disclosure, the acquisition unit 101 acquires the cyberattack information including the information of a damaged company by a plurality of cyberattack groups using a dedicated tool or a website browsable by performing specific setting. Then, the display unit 102 displays the cyberattack information by the plurality of cyberattack groups. As described above, the trend of the cyberattack can be grasped by displaying the cyberattack information of the plurality of cyberattack groups.

In particular, in a site that cannot be browsed by a normal browser such as a dark web, each cyberattack group may individually announce a crime statement. In this case, even if the attack information of each of the cyberattack groups is acquired, it is not possible to grasp which company is frequently subjected to the cyberattack by which attack group. On the other hand, as in the display device 100 of the present disclosure, by displaying the cyberattack information by the plurality of cyberattack groups, it is possible to grasp the trend of the cyberattack, and it becomes easy to grasp the damage information of the cyberattack group to be noted by the company and companies doing business with the company.

### Second Example Embodiment

Next, a second example embodiment will be described in detail with reference to the drawings. Hereinafter, description of contents overlapping with the above description will be omitted to the extent that the description of the present example embodiment is not unclear. Similarly to the computer device illustrated in FIG. 2, each component in each example embodiment of the present disclosure can be achieved not only by hardware but also by a computer device or software based on program control.

In the present example embodiment, the number of cyberattacks is displayed for each cyberattack group or each type based on the acquired cyberattack information.

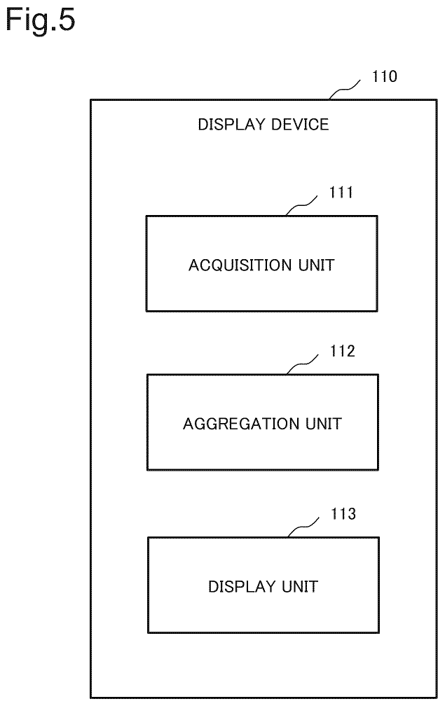

FIG. 5 is a functional block diagram illustrating an example of a configuration of the display device in the present disclosure. With reference to FIG. 5, a display device 110 will be described focusing on a portion different from the display device 100.

The display device 110 includes an acquisition unit 111, an aggregation unit 112, and a display unit 113. The acquisition unit 111 in the display device 110 is similar in configuration and function to the acquisition unit 101 in the display device 100, and thus description thereof is omitted here.

The aggregation unit 112 is a means for aggregating the number of cyberattacks for each cyberattack group or each type of damaged company based on the cyberattack information. The aggregation unit 112 extracts the cyberattack information acquired by the acquisition unit 111 for each cyberattack group or each type of damaged company, and aggregates the extracted number of cyberattacks. The type of the damaged company includes the business type of damaged company, the host country of the damaged company, or the country of the damaged company (the host country of the headquarter). The number of cyberattacks counted in this manner is output to the display unit 113.

The display unit 113 displays the number of cyberattacks for each cyberattack group or each type. A display method by the display unit 113 is similar to that of the first example embodiment. In the display device 110, the aggregation unit 112 may aggregate the number of cyberattacks of each cyberattack group or each type of damaged company a predetermined period of time ago, and the display unit 113 may display a difference in the number of cyberattacks from a predetermined period of time ago. In the display device 110, the aggregation unit 112 may aggregate the number of cyberattacks for each cyberattack group or each type of damaged company in each predetermined period, and the display unit 113 may display the number of cyberattacks in each predetermined period. In the display device 110, the aggregation unit 112 may aggregate the cumulative number of the number of cyberattacks for each cyberattack group or each type from a predetermined time, and the display unit 113 may display the cumulative number.

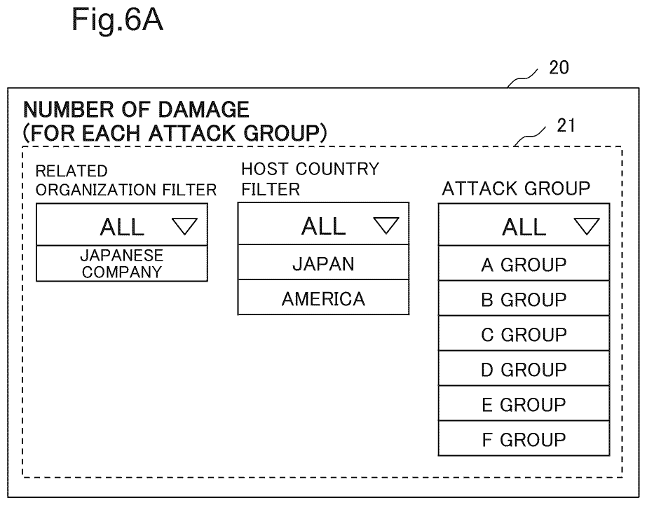

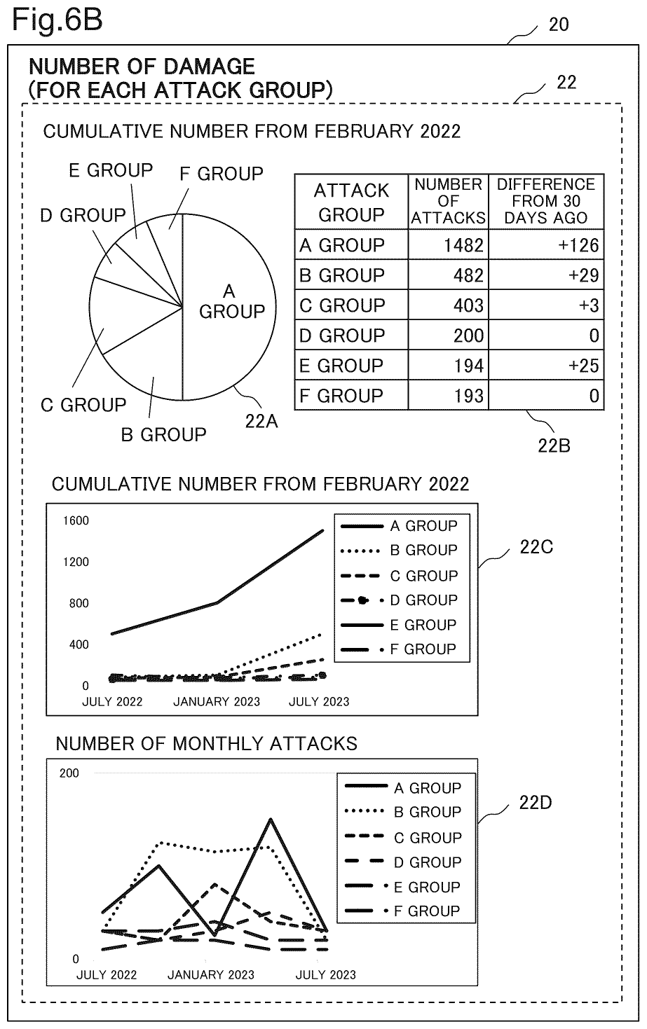

Next, display screens of the number of cyberattacks of each attack group and the number of cyberattacks of each business type of damaged company will be described with reference to FIGS. 6 to 8. FIG. 6 is an example of a display screen displaying the number of cyberattacks of each cyberattack group in the present disclosure. However, FIG. 6 is an example of displaying the number of cyberattacks of each cyberattack group, and is not limited to the example of FIG. 6. A display screen 20 of the number of cyberattacks in FIG. 6 includes a filtering region 21 for filtering the number of cyberattacks to be displayed and a display region 22 of the number of cyberattacks.

In FIG. 6, in the filtering region 21, the number of cyberattacks to be displayed in the display region 22 can be selected by a pull-down menu. As illustrated in FIG. 6, in the filtering region 21, a related organization filter, a host country filter, and a filter of an attack group are displayed, and in the example of FIG. 6, it is selected to display all the number of cyberattacks.

The related organization filter is a filter for selecting a country of a damaged company, and in the example of FIG. 6, a filter for selecting a Japanese company is illustrated. A Japanese company refers to a company of which the headquarter is located in Japan. By filtering the number of cyberattacks to be displayed by the country of the damaged company, for example, in a case where the damaged company is an overseas subsidiary of a Japanese company, other Japanese companies that have business with the damaged company can easily grasp the influence of the cyberattack. The host country filter is a filter for selecting the host country of the damaged company. The overseas subsidiary of a Japanese company is included in the host country of the subsidiary. The filter of the attack group can display the cyberattack information of only the selected group by selecting each group name.

In FIG. 6, a pie chart (22A) of the cumulative number of cyberattacks of each cyberattack group, a table (22B) of the cumulative number of cyberattacks of each cyberattack group, a polygonal line graph (22C) of the cumulative number of cyberattacks of each cyberattack group, and a polygonal line graph (22D) of the monthly number of cyberattacks of each cyberattack group are displayed in the display region 22. By displaying not only the cumulative number of cyberattacks but also the monthly number of cyberattacks, it is possible to grasp the temporal transition and tendency of the number of cyberattacks.

In the example of FIG. 6, in the table (22B) of the cumulative number of cyberattacks of each cyberattack group, the difference from the predetermined period of time ago is displayed next to the cumulative number of cyberattacks of each cyberattack group. In the example of FIG. 6, a difference from the number of cyberattacks 30 days ago is displayed.

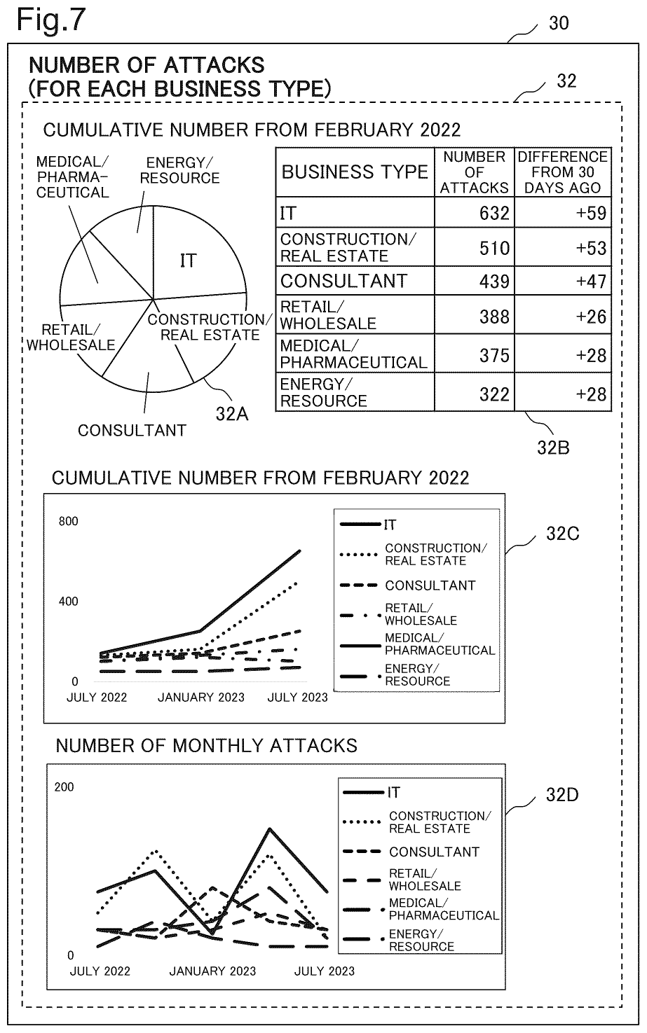

FIG. 7 is an example of a display screen of the number of cyberattacks of each type of damaged company in the present disclosure. The example of FIG. 7 displays the number of cyberattacks of each business type of damaged company. In FIG. 7, examples of business types include IT, construction/real estate, consultant, retail/wholesale, medical/pharmaceutical, and energy/resource, but the examples of business types are not limited to these classifications.

In FIG. 7, a display region 32 displays a pie chart (32A) of the cumulative number of cyberattacks of each business type, a table (32B) of the cumulative number of cyberattacks of each business type, a polygonal line graph (32C) of the cumulative number of cyberattacks of each business type, and a polygonal line graph (32D) of the monthly number of cyberattacks of each business type. In the table (32B) of the cumulative number of cyberattacks of each business type, a difference from 30 days ago is displayed next to the cumulative number of cyberattacks of each business type. As illustrated in FIG. 7, by showing the number of cyberattacks of each business type, it is possible to grasp the business type targeted by the cyberattack group.

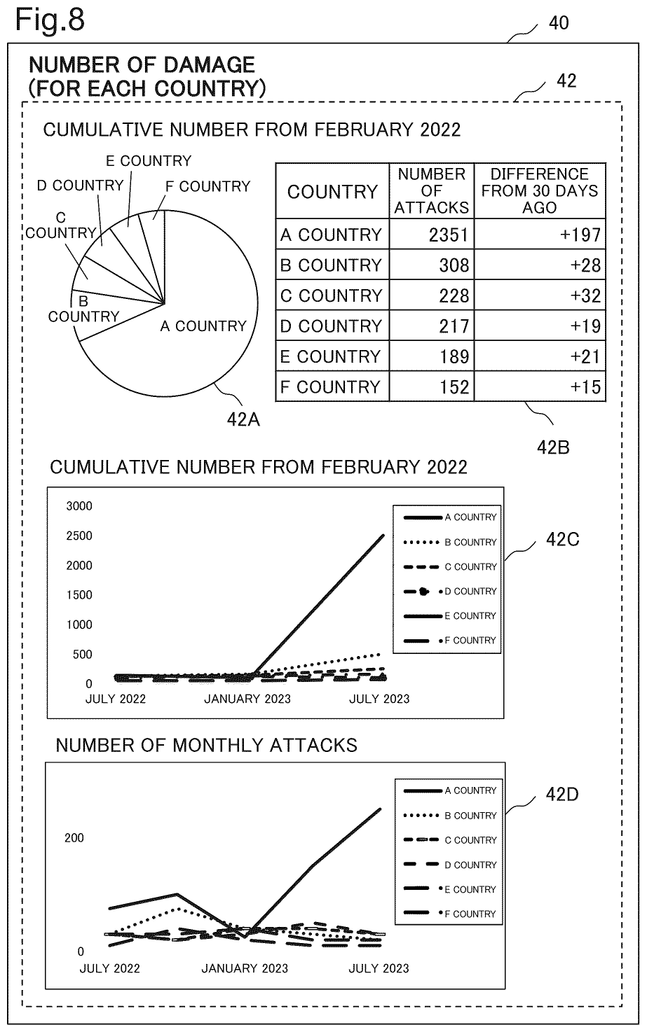

FIG. 8 is an example of a display screen of the number of cyberattacks of each type of damaged company in the present disclosure. The example of FIG. 8 displays the number of cyberattacks of the damaged company for each country. In FIG. 8, a display region 42 displays a pie chart (42A) of the cumulative number of cyberattacks of each country of the damaged company, a table (42B) of the cumulative number of cyberattacks of each country of the damaged company, a polygonal line graph (42C) of the cumulative number of cyberattacks of each country of the damaged company, and a polygonal line graph (42D) of the monthly number of cyberattacks of each country of the damaged company. In the table (42B) of the cumulative number of cyberattacks of each country of the damaged company, a difference from 30 days ago is displayed next to the cumulative number of cyberattacks of each country of the damaged company. As illustrated in FIG. 8, by showing the number of cyberattacks of the damaged company for each country, it is possible to grasp the country of the company attacked by the cyberattack group.

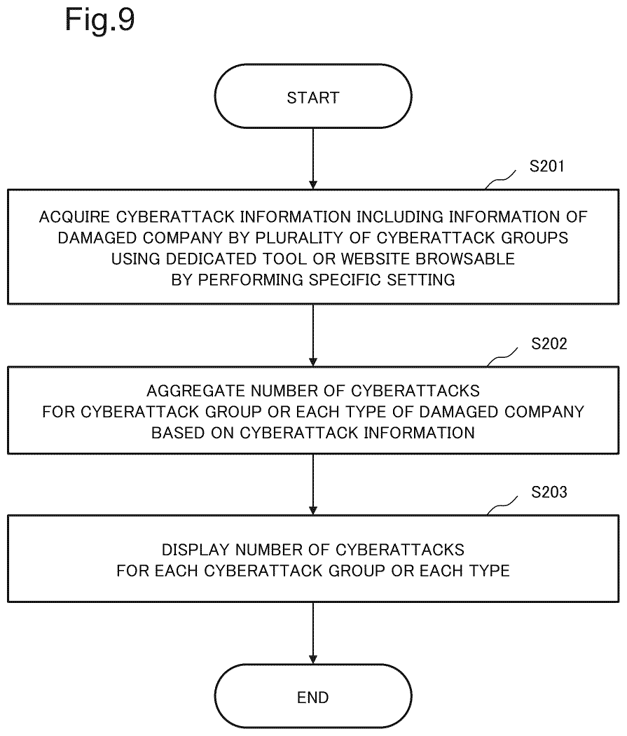

The operation of the display device 110 configured as described above will be described with reference to the flowchart of FIG. 9.

FIG. 9 is a flowchart illustrating an outline of the operation of the display device 110 in the present disclosure. The processing according to this flowchart may be executed based on program control by the processor described above.

As illustrated in FIG. 9, first, the acquisition unit 111 acquires the cyberattack information including the information of the damaged company by the plurality of cyberattack groups using a dedicated tool or a website browsable by performing specific setting (step S201). Next, the aggregation unit 112 is a means for aggregating the number of cyberattacks for each cyberattack group or each type of damaged company based on the cyberattack information (step S202). Finally, the display unit 113 displays the number of cyberattacks for each cyberattack group or each type (step S203). The processing according to the flowchart is terminated.

In the display device 110 of the present disclosure, the aggregation unit 112 aggregates the number of cyberattacks for each cyberattack group or each type of damaged company based on the cyberattack information, and the display unit 113 displays the number of cyberattacks for each cyberattack group or each type. As a result, it is possible to grasp information of an attack group having a large number of times of cyberattacks and information of a company having a large number of times of cyberattack damage.

In order to grasp the trend of the cyberattack, quantitative data indicating what kind of attack is frequently performed may be required. However, it is difficult to aggregate quantitative data from threat information regarding each cyberattack.

An example of an effect of the present disclosure is to provide a display device capable of grasping a trend of a cyberattack.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

For example, although the plurality of operations are described in order in the form of a flowchart, the order of description does not limit the order of executing the plurality of operations. Therefore, when each example embodiment is implemented, the order of the plurality of operations can be changed within a range that does not interfere with the content.

Further, it is noted that the inventor's intent is to retain all equivalents of the claimed disclosure even if the claims are amended during prosecution.

Some or all of the above example embodiments may be described as the following Supplementary Notes, but are not limited to the following.

### Supplementary Note 1

A display device including:
an acquisition means for acquiring cyberattack information including information of a damaged company by a plurality of cyberattack groups using a dedicated tool or a website browsable by performing specific setting; and
a display means for displaying the cyberattack information by the plurality of cyberattack groups.

### Supplementary Note 2

The display device according to Supplementary Note 1, further including:
an aggregation means for aggregating a number of cyberattacks for each cyberattack group or each type of damaged company based on the cyberattack information, in which
the display means displays the number of cyberattacks for each of the cyberattack groups or each of the types.

### Supplementary Note 3

The display device according to Supplementary Note 2, in which
the aggregation means aggregates the number of cyberattacks for each business type of damaged company, and
the display means displays a number of cyberattacks of each of the business types.

### Supplementary Note 4

The display device according to Supplementary Note 2, in which
the aggregation means aggregates the number of cyberattacks for each host country of the damaged company, and
the display means displays a number of cyberattacks for the each host country.

### Supplementary Note 5

The display device according to Supplementary Note 2, in which
the aggregation means aggregates the number of cyberattacks for each host country of a headquarter of the damaged company, and
the display means displays a number of cyberattacks for each host country of the headquarter.

### Supplementary Note 6

The display device according to any one of Supplementary Notes 2 to 5, in which
the aggregation means aggregates the number of cyberattacks of each of the cyberattack groups or each type of damaged company a predetermined period of time ago, and
the display means displays a difference in a number of cyberattacks from the predetermined period of time ago.

### Supplementary Note 7

The display device according to any one of Supplementary Notes 2 to 5, in which
the aggregation means aggregates the number of cyberattacks of each of the cyberattack groups or each type of damaged company in each predetermined period, and
the display means displays the number of cyberattacks in each of the predetermined periods.

### Supplementary Note 8

The display device according to any one of Supplementary Notes 2 to 5, in which
the aggregation means aggregates a cumulative number of the number of cyberattacks of each of the cyberattack groups or each type of damaged company from a predetermined time, and
the display means displays the cumulative number.

### Supplementary Note 9

A display method causing a computer to execute:
acquiring cyberattack information including information of a damaged company by a plurality of cyberattack groups using a dedicated tool or a website browsable by performing specific setting; and
displaying the cyberattack information by the plurality of cyberattack groups.

### Supplementary Note 10

The display method according to Supplementary Note 9, in which
a number of cyberattacks of each cyberattack group or each type of damaged company is further aggregated based on the cyberattack information, and
in the displaying step, the number of cyberattacks of each of the cyberattack groups or each of the types is displayed.

### Supplementary Note 11

The display method according to Supplementary Note 10, in which
in the aggregating step, the aggregation means aggregates the number of cyberattacks for each business type of damaged company, and
in the displaying step, a number of cyberattacks of each of the business types is displayed.

### Supplementary Note 12

The display method according to Supplementary Note 10, in which
in the aggregating step, the number of cyberattacks is aggregated for each host country of the damaged company, and
in the displaying step, a number of cyberattacks is displayed for each of the host countries.

### Supplementary Note 13

The display method according to Supplementary Note 10, in which
in the aggregating step, the number of cyberattacks is aggregated for each host country of a headquarter of the damaged company, and
in the displaying step, a number of cyberattacks is displayed for each host country of the headquarter.

### Supplementary Note 14

The display method according to any one of Supplementary Notes 10 to 13, in which
in the aggregating step, the number of cyberattacks of each of the cyberattack groups or each type of damaged company a predetermined period of time ago is aggregated, and
in the displaying step, a difference in a number of cyberattacks from the predetermined period of time ago is further displayed.

### Supplementary Note 15

The display method according to any one of Supplementary Notes 10 to 13, in which
in the aggregating step, the number of cyberattacks is aggregated for each of the cyberattack groups or each type of damaged company in each predetermined period, and
in the displaying step, the number of cyberattacks is displayed in each of the predetermined periods.

### Supplementary Note 16

The display method according to any one of Supplementary Notes 10 to 13, in which
in the aggregating step, a cumulative number of the number of cyberattacks is aggregated for each of the cyberattack groups or each of the types from a predetermined time, and
in the displaying step, the cumulative number is displayed.

### Supplementary Note 17

A program causing a computer to execute:
acquiring cyberattack information including information of a damaged company by a plurality of cyberattack groups using a dedicated tool or a website browsable by performing specific setting; and
displaying the cyberattack information by the plurality of cyberattack groups.

### Supplementary Note 18

The program according to Supplementary Note 17, in which
a number of cyberattacks of each cyberattack group or each type of damaged company is further aggregated based on the cyberattack information, and
in the displaying step, the number of cyberattacks of each of the cyberattack groups or each of the types is displayed.

### Supplementary Note 19

The program according to Supplementary Note 18, in which
in the aggregating step, the aggregation means aggregates the number of cyberattacks for each business type of damaged company, and
in the displaying step, a number of cyberattacks of each of the business types is displayed.

### Supplementary Note 20

The program according to Supplementary Note 18, in which
in the aggregating step, the number of cyberattacks is aggregated for each host country of the damaged company, and
in the displaying step, a number of cyberattacks is displayed for each of the host countries.

### Supplementary Note 21

The program according to Supplementary Note 18, in which
in the aggregating step, the number of cyberattacks is aggregated for each host country of a headquarter of the damaged company, and
in the displaying step, a number of cyberattacks is displayed for each host country of the headquarter.

### Supplementary Note 22

The program according to any one of Supplementary Notes 18 to 21, in which
in the aggregating step, the number of cyberattacks of each of the cyberattack groups or each type of damaged company a predetermined period of time ago is aggregated, and
in the displaying step, a difference in a number of cyberattacks from the predetermined period of time ago is further displayed.

### Supplementary Note 23

The program according to any one of Supplementary Notes 18 to 21, in which
in the aggregating step, the number of cyberattacks is aggregated for each of the cyberattack groups or each type of damaged company in each predetermined period, and
in the displaying step, the number of cyberattacks is displayed in each of the predetermined periods.

### Supplementary Note 24

The program according to any one of Supplementary Notes 18 to 21, in which
in the aggregating step, a cumulative number of the number of cyberattacks is aggregated for each of the cyberattack groups or each of the types from a predetermined time, and
in the displaying step, the cumulative number is displayed.

1. A display device comprising:
at least one memory configured to store instructions; and
at least one processor configured to execute the instructions to:
acquire cyberattack information including information of a damaged company by a plurality of cyberattack groups using a dedicated tool or a website browsable by performing specific setting; and
display the cyberattack information of the plurality of cyberattack groups.

2. The display device according to claim 1, wherein the at least one processor is further configured to execute the instructions to:
aggregate a number of cyberattacks for each cyberattack group or each type of damaged company based on the cyberattack information; and
display the number of cyberattacks for each of the cyberattack groups or each of the types.

3. The display device according to claim 2, wherein the at least one processor is further configured to execute the instructions to:
aggregate the number of cyberattacks for each business type of damaged company; and
display the number of cyberattacks of each business type.

4. The display device according to claim 2, wherein the at least one processor is further configured to execute the instructions to:
aggregate the number of cyberattacks for each host country of the damaged company; and
display the number of cyberattacks for the each host country.

5. The display device according to claim 2, wherein the at least one processor is further configured to execute the instructions to:
aggregate the number of cyberattacks for each host country of a headquarter of the damaged company; and
display the number of cyberattacks for each host country of the headquarter.

6. The display device according to claim 2, wherein the at least one processor is further configured to execute the instructions to:
aggregate the number of cyberattacks of each of the cyberattack groups or each type of damaged company a predetermined period of time ago; and
display a difference in the number of cyberattacks from the predetermined period of time ago.

7. The display device according to claim 2, wherein the at least one processor is further configured to execute the instructions to:
aggregate the number of cyberattacks for each of the cyberattack groups or each type of damaged company in each predetermined period; and
display the number of cyberattacks in each predetermined period.

8. The display device according to claim 2, wherein the at least one processor is further configured to execute the instructions to:
aggregate a cumulative number of the number of cyberattacks for each of the cyberattack groups or each of the types from a predetermined time; and
display the cumulative number.

9. A display method comprising:
acquiring cyberattack information including information of a damaged company by a plurality of cyberattack groups using a dedicated tool or a website browsable by performing specific setting; and
displaying the cyberattack information by the plurality of cyberattack groups.

10. The display method according to claim 9, further comprising:
aggregating a number of cyberattacks for each cyberattack group or each type of damaged company based on the cyberattack information; and
displaying the number of cyberattacks for each of the cyberattack groups or each of the types.

11. The display method according to claim 10, further comprising:
aggregating the number of cyberattacks for each business type of the damaged company; and
displaying the number of cyberattacks of each of the business types.

12. The display method according to claim 10, further comprising:
aggregating the number of cyberattacks for each host country of the damaged company; and
displaying the number of cyberattacks for the each host country.

13. The display method according to claim 10, further comprising:
aggregating the number of cyberattacks for each host country of a headquarter of the damaged company; and
displaying the number of cyberattacks for each host country of the headquarter.

14. The display method according to claim 10, further comprising:
aggregating the number of cyberattacks of each of the cyberattack groups or each type of damaged company a predetermined period of time ago; and
displaying a difference in the number of cyberattacks from the predetermined period of time ago.

15. A non-transitory computer-readable recording medium that records a program for causing a computer to execute:
acquiring cyberattack information including information of a damaged company by a plurality of cyberattack groups using a dedicated tool or a website browsable by performing specific setting; and
displaying the cyberattack information of the plurality of cyberattack groups.

16. The recording medium, according to claim 15, that records the program for causing the computer to further execute:
aggregating a number of cyberattacks for each cyberattack group or each type of damaged company based on the cyberattack information; and
displaying the number of cyberattacks for each of the cyberattack groups or each of the types.

17. The recording medium, according to claim 16, that records the program for causing the computer to further execute:
aggregating the number of cyberattacks for each business type of the damaged company; and
displaying the number of cyberattacks of each of the business types.

18. The recording medium, according to claim 16, that records the program for causing the computer to further execute:
aggregating the number of cyberattacks for each host country of the damaged company; and
displaying the number of cyberattacks for the each host country.

19. The recording medium, according to claim 16, that records the program for causing the computer to further execute:
aggregating the number of cyberattacks for each host country of a headquarter of the damaged company; and
displaying the number of cyberattacks for the host country of the headquarter.

20. The recording medium, according to claim 16, that records the program for causing the computer to further execute:
aggregating the number of cyberattacks of each of the cyberattack groups or each type of damaged company a predetermined period of time ago; and
displaying a difference in the number of cyberattacks from the predetermined period of time ago.
